(19) United States
(12) Patent Application Publication
(10) Pub. No.: US 2019/0277337 A1
(43) Pub. Date: Sep. 12, 2019

(54) ACTIVE MAGNETIC BEARING AND METHOD FOR COOLING THE ACTIVE MAGNETIC BEARING

(71) Applicant: Siemens Aktiengesellschaft, 80333 München (DE)

(72) Inventors: THEODORA TZIANETOPOULOU, Athens (GR); BERT-UWE KÖHLER, Falkensee (DE); MATTHIAS LANG, Berlin (DE)

(73) Assignee: Siemens Aktiengesellschaft, 80333 München (DE)

(21) Appl. No.: 16/319,166

(22) PCT Filed: Jul. 18, 2017
(86) PCT No.: PCT/EP2017/068108

§ 371 Date: Jan. 18, 2019

(30) Foreign Application Priority Data
Jul. 19, 2016 (EP) 16180128.7

(51) Int. Cl. F16C 32/04; F16C 37/00

(52) U.S. Cl. CPC F16C 32/0474; F16C 37/005

(57) ABSTRACT

An active magnetic bearing of a shaft, which shaft can be rotated about an axis, includes a magnetically conductive main body, which is arranged in a stationary manner and which surrounds the shaft. Partial bodies are arranged one behind the other axially at an axial distance between adjacent partial bodies and form the magnetically conductive main body. A winding system is arranged in grooves of the magnetically conductive main body.

The invention relates to an active magnetic bearing and a method for cooling an active magnetic bearing.

Active magnetic bearings are used with comparatively high turbomachinery speeds and in machine-tool manufacture or in clean room technology since magnetic bearings do not produce any contaminating abrasion.

With active magnetic bearings, an electromagnet generates a corresponding magnetic force. Herein, the power required for this should be constantly adjusted via a control loop. For the cooling of the active magnetic bearing or the components, a magnetic bearing is known for example from DE 203 18 389 U1 with which a magnetic field is generated by a high-temperature superconductor. The coolant system required for this comprises liquid nitrogen to maintain superconductivity.

Also known from DE 10 2005 032 674 A1 is an active magnetic bearing with which heat sinks are provided on the bearing housing in order to remove thermal losses from an amplifier.

Proceeding from this, the invention is based on the object of providing an active magnetic bearing that provides a sufficiently efficient bearing system in different temperature ranges.

The object is achieved by an active magnetic bearing of a shaft that can be rotated about an axis having
a magnetically conductive main body, which is arranged in a stationary manner and which surrounds the shaft,
partial bodies, which are arranged one behind the other axially and which form the magnetically conductive main body,
a winding system, which is arranged in grooves of the magnetically conductive main body,
an axial distance between the adjacent partial bodies.

The object is also achieved by a method for cooling an active magnetic bearing of a shaft that can be rotated about an axis having
a magnetically conductive main body which is arranged in a stationary manner and which surrounds the shaft,
partial bodies, which are arranged one behind the other axially and which form the magnetically conductive main body,
a winding system, which is arranged in grooves of the magnetically conductive main body,
spacers between the adjacent partial bodies, wherein cooling air flowing substantially axially onto the magnetically conductive main body flows axially through axially extending cooling ducts in the magnetically conductive main body or gaps located in the interspaces between the windings in order to exit at least partially radially at the axially adjacent spacer, which is located between two partial bodies that are axially spaced apart from one another.

The axial division of the magnetically conductive main body of an active magnetic bearing into partial bodies that are axially spaced apart from one another and preferably each have an axially stacked lamination now enables one or more cooling air streams that are independent of one another to exit at least partially radially through special axial cooling ducts in the magnetically conductive main body and/or in the axially extending grooves and thus to cool the magnetically conductive main body and hence also the winding system of the magnetic bearing.

The adjacent partial bodies are spaced apart from one another by means of spacers. In this way, individual bars arranged substantially radially between adjacent partial bodies create radial cooling air ducts between the partial bodies.

As an alternative to the bars, the spacers between the adjacent partial bodies can also be embodied as a disk, which is made in one piece and also comprises radial and/or axial cooling ducts. These disks are preferably made of a magnetically non-conductive material, such as, for example plastic.

The invention and further advantageous embodiments of the invention are explained in more detail with reference to schematically depicted exemplary embodiments. In the figures:

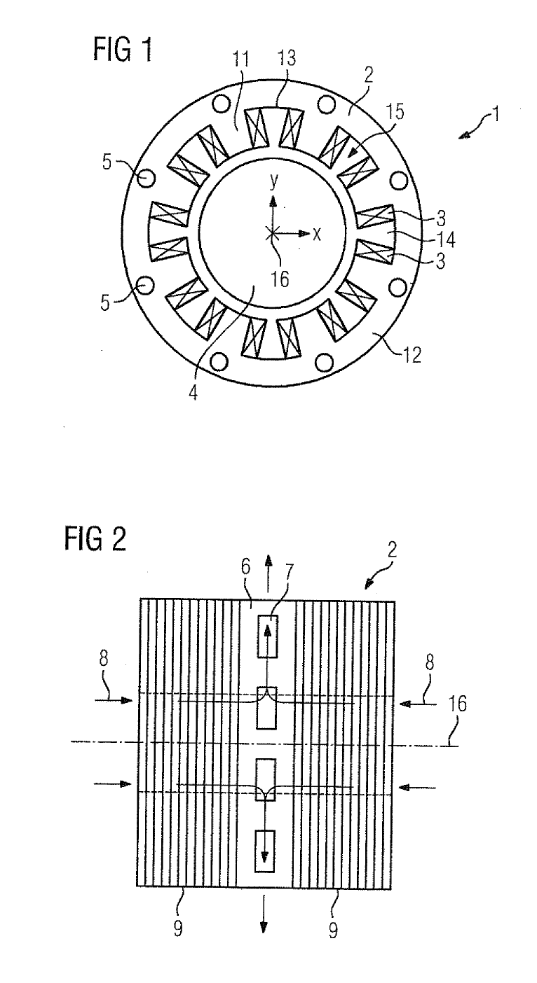

FIG. 1 shows the basic arrangement of an active magnetic bearing,

FIG. 2 shows a magnetic main body,

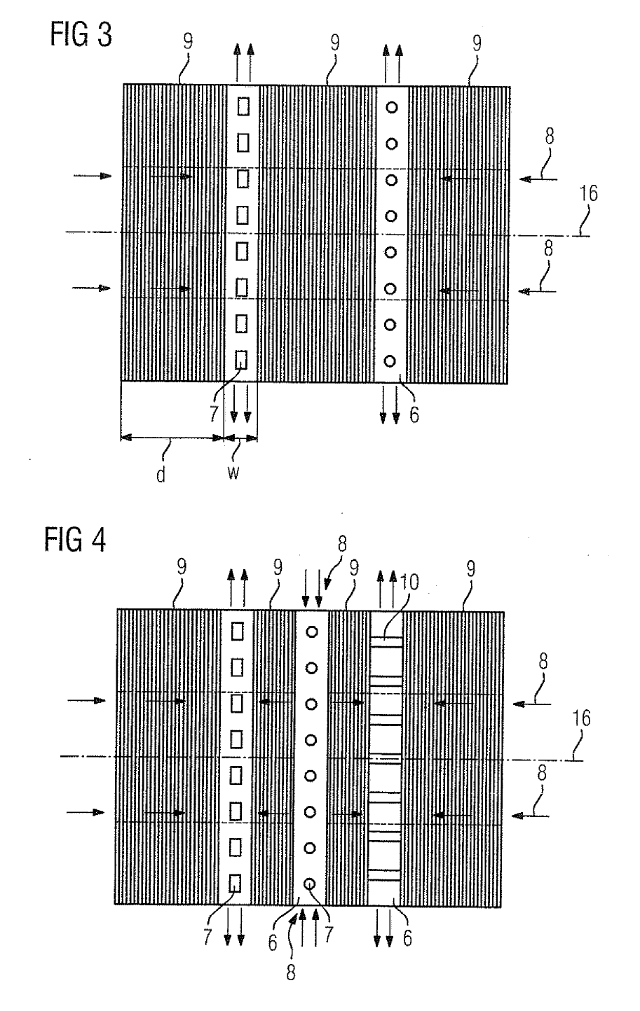

FIG. 3 shows an alternative embodiment of the magnetic main body,

FIG. 4 shows a further alternative embodiment of the magnetic main body,

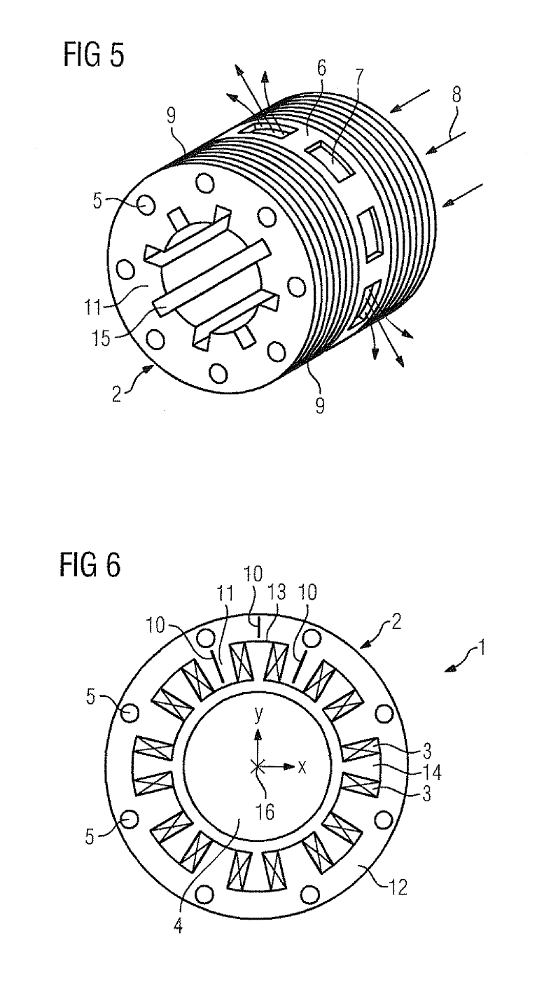

FIG. 5 shows a partial perspective view of a magnetic main body,

FIG. 6 shows a cross section of a main body with bars,

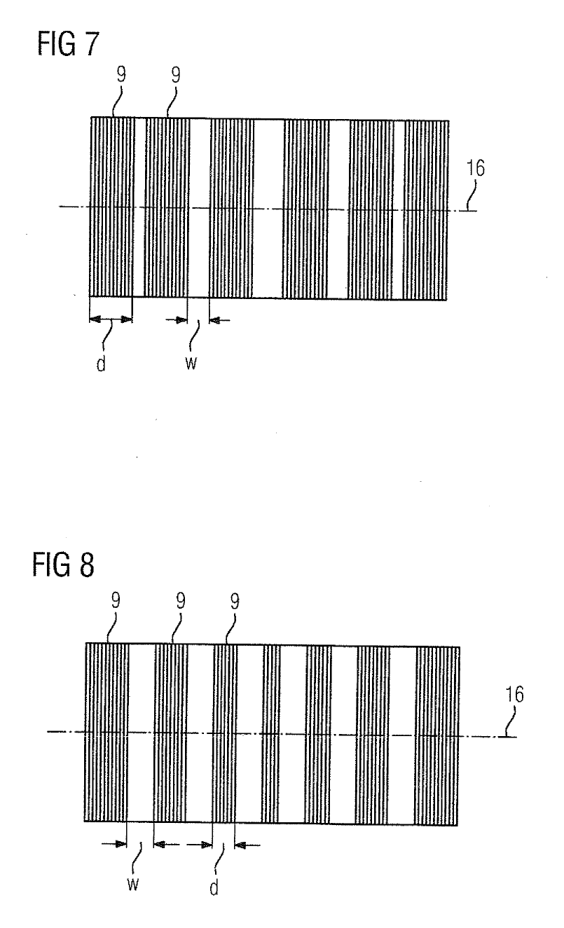

FIG. 7 shows a magnetic main body with partial bodies that are spaced apart from one another in a non-uniform manner,

FIG. 8 shows a magnetic main body with partial bodies that are spaced apart from one another in a uniform manner.

FIG. 1 shows a rotor of an active magnetic bearing 1, which is held by the bearing force in the center of a borehole in a magnetic main body 2 and positioned inside this borehole of the magnetically conductive main body 2 by corresponding control methods and control devices, which are not shown in further detail. Also shown is a backup bearing, which is not shown in further detail, that takes over the bearing function temporarily if the control etc. fails.

The rotor is part of a shaft 4 or mechanically connected to a shaft 4 of a drive in a non-rotatable manner. Such drives are used, for example, in turbomachinery, high-frequency milling spindles, pumps, ultracentrifuges etc.

FIG. 2 shows the magnetic bearing 1 with the magnetically conductive main body 2, which is constructed in the axial direction by partial bodies 9. These partial bodies 9 are spaced apart from one another axially, wherein in each case spacers are provided between axially adjacent partial bodies. Herein, the spacers can be one-piece disks 6 comprising radial and/or axially extending cooling ducts 7.

These spacers can also be radially extending bars 10 applied individually to a partial body 9. Herein, radial and/or axially extending cooling ducts 7 are also established in the main body 2.

Each partial body 9 has a predefinable number of individual sheets so that a spacer of this kind can be provided as an arrangement of bars 10 or of one or more disks 6 in accordance with a predefined number of sheets that form a partial body 9.

The axial thickness d of the partial bodies 9 and/or the axial width of the distance w between the adjacent partial bodies 9 can vary over the entire axial length of the main body 2. These possibilities in the structure of the main body 2 enable a homogenized temperature distribution to be induced in the magnetic bearing 1, in particular in the main body 2.

The magnetically conductive main body 2 in FIG. 3 comprises three partial bodies 9 in each case comprising a disk 6 as a spacer between two axially adjacent partial bodies 9 with different cooling openings or cooling cross sections depicted by way of example.

FIG. 4 furthermore shows a magnetic main body 2 comprising four partial bodies 9, wherein one cooling air stream 8 is diverted radially over the middle disk 6 and axially on the respective end faces in the magnetic main body 2. The heated cooling air 8 exits in the two axially outer spacers, which are formed as a disk 6 or by bars 10.

However, the entry and exit points of the cooling air stream can be adapted to the respective type of construction of the active magnetic bearing 1.

FIG. 5 is a partial perspective view of the magnetic bearing 1 with the magnetically conductive main body 2, which is constructed in the axial direction from partial bodies 9. These partial bodies 9 are axially spaced apart from one another, wherein in each case spacers are provided between axially adjacent partial bodies 9. Herein, the spacers can be one-piece disks 6 comprising radial and/or axially extending cooling ducts 7.

These spacers can also be radially extending bars 10 applied individually to a partial body 9, which are not shown in more detail in this depiction. Herein, radial and/or axially extending cooling ducts 7 are also established in the main body 2.

Each of the partial bodies 9 has a laminated structure so that such a spacer can be provided as an arrangement of bars 10 or one or more disks 6 in accordance with a predefined number of sheets that form a partial body 9.

The axial thickness d of the partial bodies 9 and/or the axial width of the distance w between the adjacent partial bodies 9 can vary over the entire axial length of the main body 2. These possibilities in the structure of the main body 2 enable a homogenized temperature distribution to be induced in the magnetic bearing 1, in particular in the main body 2.

The axial cooling ducts 5, 14 and radial cooling ducts 7 in the spacers 6, 10 between the partial body 9 that are now provided can now carry a cooling air stream, which basically enters the magnetically conductive main body 2 from one side and exits at the spacers and the radial cooling ducts provided thereby, and also a stream, which initially penetrates the magnetically conductive main body 2 via the radial cooling ducts of the spacers where it is distributed axially into the cooling ducts 5, 14 provided.

Thus, the cooling ducts 5, 14 provided axially can be axially extending recesses provided in the magnetically conductive main body 2. The axial cooling ducts 5, 14 can also be located in the interspaces of the grooves 15, which are not exposed to stress from the winding 3.

The cooling of the active magnetic bearing 1 according to the invention now enables a more compact design of such a magnetic bearing 1 even in large-scale applications in more cramped space conditions.

FIG. 6 shows different arrangements and lengths of bars 10 located between the partial bodies 9. In a cross section of the main body 2, bars 10 extend as spacers over a certain tooth height, i.e. the radial course of a tooth 11. The bars 10 can also be arranged on the yoke back 12 and extend from groove base 13 at the most to the radially outer edge of the magnetic main body 2. Also conceivable are bars 10 that extend from the stator borehole as far as the radially outer edge of the magnetic main body 2. Such bars 10 are also depicted as spacers on the right of FIG. 4.

FIG. 7 shows a magnetic main body 2 comprising a plurality of partial bodies 9 with the same axial width d. The axial distances w between the partial bodies 9 can be different and, in particular toward the middle of the main body 2, continuously increase in size. As a result, the winding components and partial bodies 9 located within the main body 2 are cooled sufficiently, Herein, the middle partial bodies 9 have the greatest axial distance.

FIG. 8 shows a magnetic main body 2 comprising a plurality of partial bodies 9 with a different axial width d, wherein the axial distances w of the adjacent partial bodies 9 are the same. The axial widths d of the partial bodies 9 can differ and, in particular toward the middle of the main body 2, continuously decrease in size. Herein, the partial bodies or the partial body 9 in the middle of the main body 2 have the smallest axial width d. As a result, the winding components and partial bodies 9 located within the main body 2 are cooled sufficiently.

The cooling of the active magnetic bearing 1 with a shaft 4 that can be rotated about the axis 16 and a magnetically conductive main body 2 which is arranged in a stationary manner and which surrounds the shaft 4, wherein the partial bodies 9, which are arranged one behind the other axially and which form the magnetically conductive main body 2, wherein one or more windings 3 are arranged in grooves 15 of the magnetically conductive main body 2 and spacers are 6, 10 are provided between the adjacent partial bodies 9 is basically provided by an internally or externally generated cooling air stream. The cooling air stream 8 is provided by correspondingly embodied fans, radial and/or axial fans.

One of several cooling possibilities is provided by cooling air 8 that flows substantially axially onto the magnetically conductive main body 2, which flows axially through axially extending cooling ducts 5 in the magnetically conductive main body 2 or in gaps located in the interspaces between the windings 3 in order to exit at least partially radially at the axially adjacent spacer, which is located between two partial bodies 9 that are axially spaced apart from one another. Herein, the spacer is provided by a disk 6 or a spacer formed by bars 10. The residual cooling air stream in the main body 2 is forwarded axially in order either to exit the main body 2 axially or, at the next spacer, to exit the main body 2 at least partially radially again.

The cooling air streams 8 depicted in the FIG. 2 to FIG. 5 are examples and can also be reversed by corresponding measures, such as, for example, another direction of rotation of the above-mentioned fans.

Also conceivable are other cooling air distributions; herein the decisive fact is in each case to maintain an almost constant temperature level, particularly in the magnetic main body 2.

The active magnetic bearing 1 and the method for cooling such an active magnetic bearing 1 are used, for example, in compressors, pumps, centrifuges and conveying systems in the foodstuff, chemical and pharmaceutical industries. Sufficient cooling is above all essential with a compact or encapsulated design of the active magnetic bearing 1.

What is claimed is:

1.-6. (canceled)

7. An active magnetic bearing of a shaft rotatable about an axis, said active magnetic bearing comprising:
a stationary magnetically conductive main body arranged in surrounding relationship to the shaft, said magnetically conductive main body being formed by a plurality of spaced-apart partial bodies arranged behind one another in an axial direction at an axial distance from one another to define interspaces therebetween, with at least one of the partial bodies comprising axially extending cooling ducts which open into the interspaces between the axially spaced apart partial bodies,
a winding system arranged in grooves of the magnetically conductive main body; and
spacers placed between the spaced-apart partial bodies.

8. The active magnetic bearing of claim 7, wherein the spacers are configured as individual bars between the axially spaced apart partial bodies.

9. The active magnetic bearing of claim 7, wherein the spacers between the partial bodies are configured as a one-piece disk.

10. A method for cooling an active magnetic bearing of a shaft rotatable about an axis, said method comprising:
arranging a spacer between axially spaced-apart adjacent partial bodies of a stationary magnetically conductive main body in surrounding relationship to the shaft; and
directing a cooling air flowing substantially axially onto the magnetically conductive main body through axial cooling ducts in the magnetically conductive main body and/or interspaces between windings that are arranged in grooves of the magnetically conductive main body, such that the cooling air exits the spacer at least partially radially.
